(19) United States
(12) Patent Application Publication
(10) Pub. No.: US 2006/0110529 A1
(43) Pub. Date: May 25, 2006

(54) Method and apparatus for finishing articles

(76) Inventor: John E. Lockshaw, Redmond, OR (US)

Correspondence Address: GLENN C. BROWN, PC, 777 NW WALL STREET, SUITE 308, BEND, OR, 97701, US

(21) Appl. No.: 10/993,796

(22) Filed: Nov. 19, 2004

(51) Int. Cl. B05D 3/12; B05C 13/02

(52) U.S. Cl. 427/240; 118/52

(57) ABSTRACT

An apparatus for applying a finish to a wooden article comprises a rotating platen including a generally planar surface for receiving a surface of the wooden article, a shaft protruding from the planar surface, and a shaft support having at least one rotating member for supporting the shaft, the platen and shaft angled upwardly toward one end when supported in the shaft support. One end of the shaft is adapted for engaging a drive motor. The drive motor is operably engaged with the shaft. The motor is adapted to rotate the shaft at approximately one revolution per minute. The shaft support comprises a generally planar body and a pair of wheels spaced apart a distance selected to rotatably support the shaft. The shaft is angled upwardly at about one fourth of an inch per foot.

### BACKGROUND OF THE INVENTION

1. Technical Field

This invention relates to the finishing of wooden articles of pottery and the like, and in particular to a method and apparatus for finishing wooden articles with glazing materials that cannot now be used on certain types of articles.

2. Field of the Invention

There are many known forms of finishes for ceramic pottery, and well known methods for their application. However, glazes and methods are not suitable for application to all materials. For example, in the case of wooden articles, ceramic glazes are not suitable, and other suitable finishes cannot be applied evenly over a curved surface. There are glazes suitable for wooden articles that can be applied to flat surfaces. However, there are not any known methods for evenly applying a finish to a wooden article with curved surfaces, such as a bowl or a vase.

### BRIEF SUMMARY OF THE INVENTION

Accordingly, a first object of this invention is to provide a method and apparatus for applying a glaze to a wooden article such that the glaze is uniformly applied.

Another object of this invention is to provide a method and apparatus for applying a glaze to a wooden article such that the thickness of the glaze is approximately the same over the entire surface of the article.

The above objects of this invention can be accomplished by providing an apparatus comprising a rotating platen wherein the wooden article is attached to the rotating platen. The rotating platen is attached to a shaft and the shaft has a shaft support having at least one rotating member for supporting the shaft. The platen and shaft are angled upwardly toward one end when supported in the shaft support. The shaft is attached to a drive motor at one end. The drive motor rotates the shaft at about 1 rpm.

The above objects of this invention can be accomplished by a method that comprises mounting a wooden article on a rotatable platen so that the wooden article is angled upwardly, rotating the platen and the wooden article at about 1 rpm, applying a finishing material to the wooden article, and rotating the platen and the wooden article for a period of time sufficient to smooth the finish.

### BRIEF DESCRIPTION OF THE DRAWINGS

The nature, principle and utility of the present invention will be clearly understood from the following detailed description when read in conjunction with the accompanying drawings, wherein:

FIG. 1 is a side view of the apparatus.

FIG. 2 is a side view of the shaft and platen.

FIG. 3 is a perspective view of the shaft support member.

The drawings are for illustrative purposes only and are not drawn to scale. In the drawings, the same numbers are used for the same part or portion throughout the drawings.

### DETAILED DESCRIPTION OF THE INVENTION

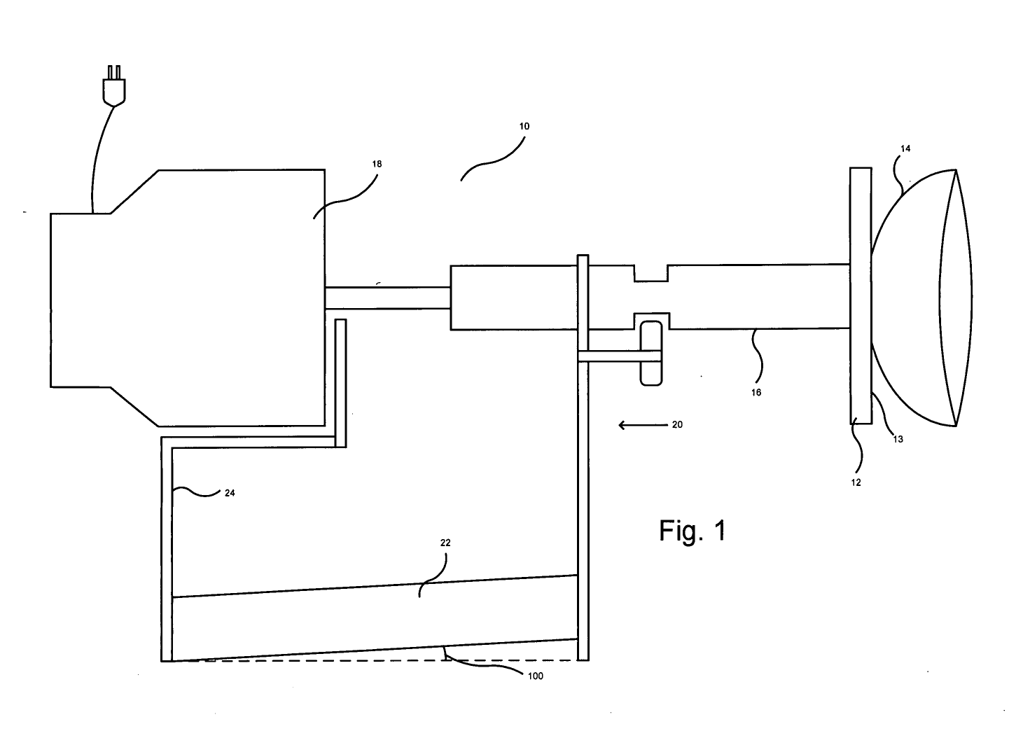

FIGS. 1-3 show an apparatus for evenly applying a finish to a wooden article. FIG. 1 shows that the apparatus 10 comprises a rotatable platen 12 with a flat surface 13 for supporting the wooden article 14. The platen 12 is disposed at one end of a shaft 16 while the other end of the shaft 16 is attached to a drive motor 18. In order to support the shaft 16, the apparatus 10 also comprises a shaft support 20, which is described in greater detail below. The shaft support 20 is mounted to one side of a mounting block 22, while a motor mounting bracket 24 is mounted on the other side of the mounting block 22. Thus, the entire apparatus 10 is portable.

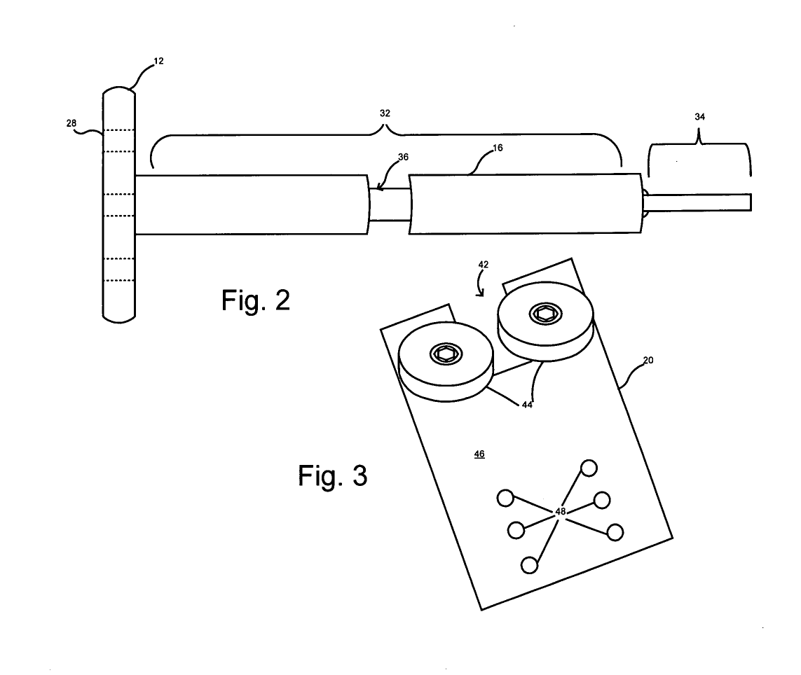

FIG. 2 is a side view of the shaft 16 and the platen 12 in greater detail. The platen 12 is attached to one side of the shaft 16. The platen 12 is attached to the shaft 16 by welding, adhering, or other suitable methods. The platen 12 includes holes 28. The other end 34 of the shaft 16 is adapted to be attached to the motor 18. Preferably, the body 32 of the shaft 16 is round while the end section 34 of the shaft 16 is square to accommodate the motor 18. The shaft 16 also includes a groove 36 for accommodating the shaft support member 20.

As shown in FIG. 3, the shaft support member 20 includes a groove 42 with a wheel 44 on either side of the groove 42. The groove 42 is wider than the body 32 of the shaft 16. The body 46 of the shaft support 20 includes several sets of holes 48. Attaching means, such as screws are positioned through one of the sets of holes 48 and into the mounting block 22 to attach the shaft support 20 to the mounting block 22. The height of the shaft support can be adjusted by using one of the other sets of holes 48 when attaching the shaft support 20 to the mounting block 22.

In operation, the end section 34 of the shaft 16 is attached to the motor 18 and the groove 36 of the shaft is in contact with the wheels 44 of the shaft support 20. A wooden article 14 is attached to the platen 12 by inserting attaching means, such as screws, through the holes 28 in the platen 12 and into the bottom surface of the wooden article 14. The apparatus 10 is positioned at an angle 100 to facilitate spreading of the finish. When the motor 18 is turned on, the shaft 16 rotates and the wheels 44 on the shaft support facilitate the rotating motion. While the shaft 16 and the wooden article 14 are rotating, a finish is applied to the inside and/or outside surfaces of the wooden article 14 with a brush or other suitable applicator. After the finish is applied, the apparatus 10 rotates the wooden article 14 for a sufficient amount of time to evenly distribute the finish.

The angle 100 of the apparatus 10 and the rotation rate of the motor can be adjusted to achieve desired results. Preferably, the angle 100 of the apparatus is ¼ inch per foot and the rotation rate is 1 revolution per minute. It has been found that such an angle and rotation rate allow for a very even coating without allowing the finish to agglomerate on any portion of the article.

While the invention has been described by reference to the preferred embodiments described above those skilled in the art will recognize that the invention as described and illustrated can be modified in arrangement and detail without departing from the scope of the invention.

What is claimed is:

1. A method of finishing a wooden article comprising the steps of:
providing a wooden article having a first axis of rotation and an outer surface;
providing a rotatable platen having a second, inclined axis of rotation;
mounting the wooden article on the rotatable platen with the first axis of rotation angled upwardly away from the platen;
rotating the platen and the wooden article at a predetermined rotation rate;
applying a finishing material to the wooden article; and
rotating the platen and the wooden article for a period of time sufficient to smooth the finishing material.

2. A method of finishing a wooden article according to claim 1 wherein the step of rotating the platen and the wooden article further comprises rotating the platen and the wooden article at a rate of about 1 revolution per minute.

3. A method of finishing a wooden article according to claim 1 wherein the rotatable platen includes a generally planar surface for receiving a surface of the wooden article, a shaft mounted on the planar surface, and a motor operatively engaged with the shaft for rotating the shaft and the platen.

4. A method of finishing a wooden article according to claim 3 wherein the rotatable platen is mounted on a portable base.

5. A method of finishing a wooden article according to claim 4 where the shaft further comprises a support member having at least one rotatable support member engageable with the shaft.

6. An apparatus for applying a finish to a wooden article comprising:
a rotating platen including a generally planar surface for receiving a surface of the wooden article;
a shaft protruding from the planar surface; and
a shaft support having at least one rotating member for supporting the shaft, the platen and the shaft angled upwardly toward one end when supported in the shaft support.

7. An apparatus according to claim 6 further comprising the shaft having an end adapted for engaging a drive motor.

8. An apparatus according to claim 7 further comprising the drive motor operably engaged with the shaft.

9. An apparatus according to claim 8 wherein the motor is adapted to rotate the shaft at approximately one revolution per minute.

10. An apparatus according to claim 6 where in the shaft support comprises a generally planar body and a pair of wheels spaced apart a distance selected to rotatably support the shaft.

11. An apparatus according to claim 6 wherein the shaft is angled upwardly at about one fourth of an inch per foot.
